(19) United States
(12) Patent Application Publication
(10) Pub. No.: US 2023/0175101 A1
(43) Pub. Date: Jun. 8, 2023

(54) METHOD FOR PRODUCING TiAl ALLOY MEMBER AND SYSTEM FOR PRODUCING TiAl ALLOY MEMBER

(71) Applicants: MITSUBISHI HEAVY INDUSTRIES ENGINE & TURBOCHARGER, LTD., Sagamihara-shi, Kanagawa (JP); TOHOKU UNIVERSITY, Sendai-shi, Miyagi (JP)

(72) Inventors: Keisuke SHINZAWA, Kanagawa (JP); Atsushi TAKITA, Kanagawa (JP); Akihiko CHIBA, Miyagi (JP)

(73) Assignees: MITSUBISHI HEAVY INDUSTRIES ENGINE & TURBOCHARGER, LTD., Sagamihara-shi, Kanagawa (JP); TOHOKU UNIVERSITY, Sendai-shi, Miyagi (JP)

(21) Appl. No.: 17/605,381

(22) PCT Filed: May 23, 2019
(86) PCT No.: PCT/JP2019/020550

§ 371 Date: Apr. 22, 2022

(51) Int. Cl. C22C 14/00; C22F 1/18; B22F 10/64; B22F 10/28; B33Y 10/00; B33Y 40/20; B33Y 30/00; B22F 12/80

(52) U.S. Cl. CPC C22C 14/00; C22F 1/183; B22F 10/64; B22F 10/28; B33Y 10/00; B33Y 40/20; B33Y 30/00; B22F 12/80; B22F 2301/205; B22F 2304/10; B22F 2998/10; B33Y 50/02

(57) ABSTRACT

A method for producing a TiAl alloy member includes a molding step (S10) of laminating a solidified body obtained by melting and solidifying or sintering powder of a TiAl alloy by irradiation of the powder with a beam, to mold a laminated body; and a heat treatment step (S12) of heating the laminated body at a setting temperature that is equal to or higher than a temperature at which a phase transformation to an α phase is initiated, to produce a TiAl alloy member. By the method for producing a TiAl alloy member, the TiAl alloy member can be easily molded with a decrease in high temperature properties suppressed.

### FIELD

The present invention relates to a method for producing a TiAl alloy member and a system for producing a TiAl alloy member.

### BACKGROUND

A TiAl alloy is an alloy (intermetallic compound) configured to bond titanium (Ti) and aluminum (Al), and is light in weight and has a high strength at a high temperature. For this reason, the TiAl alloy is applied to high-temperature structural materials for engines and aerospace devices, and the like. In Patent Literature 1, production of a turbine blade by machining a TiAl alloy is described.

### CITATION LIST

### Patent Literature

Patent Literature 1: Japanese Patent Application Laid-open No. 2002-356729

### SUMMARY

### Technical Problem

However, since machining properties of the TiAl alloy are not high, molding may be difficult. The TiAl alloy is sometimes used at a high temperature. Therefore, suppression of a reduction in properties at a high temperature is desired. Accordingly, a TiAl alloy member that is easily molded with a reduction in high temperature properties suppressed is required.

The present invention has been made to solve the aforementioned problems, and an object of the present invention is to provide a method for producing a TiAl alloy member that can be easily molded with a reduction in high temperature properties suppressed, and a system for producing the TiAl alloy member.

### Solution to Problem

In order to solve the aforementioned problems and achieve the object, a method for producing a TiAl alloy member according to the present disclosure includes: a molding step of laminating a solidified body obtained by melting and solidifying or sintering powder of a TiAl alloy by irradiation of the powder with a beam, to mold a laminated body; and a heat treatment step of heating the laminated body at a setting temperature that is equal to or higher than a temperature at which α phase transformation to an α phase is initiated, to produce a TiAl alloy member.

According to this method, a lamellar structure can be suitably formed. Therefore, the TiAl alloy member can be easily molded with a reduction in high temperature properties suppressed.

At the heat treatment step, the setting temperature is preferably a temperature at which the laminated body is an α single phase. According to this method, a reduction in high temperature properties of the TiAl alloy member can be more suitably suppressed.

At the heat treatment step, the setting temperature is preferably 1,300° C. or higher and 1,500° C. or lower. According to this method, a reduction in high temperature properties of the TiAl alloy member can be more suitably suppressed.

A cooling step of cooling the heated laminated body is preferably further included. According to this method, a reduction in high temperature properties of the TiAl alloy member can be more suitably suppressed.

At the molding step, the powder is preferably irradiated with an electron beam as the beam. According to this method, a reduction in high temperature properties of the TiAl alloy member can be more suitably suppressed.

In order to solve the aforementioned problems and achieve the object, a system for producing a TiAl alloy member according to the present disclosure includes: a molding device in which a solidified body obtained by melting and solidifying or sintering powder of a TiAl alloy by irradiation of the powder with a beam is laminated, to mold a laminated body; and a heat treatment device in which the laminated body is heated at a setting temperature that is equal to or higher than a temperature at which a phase transformation to an α phase is initiated, to produce a TiAl alloy member. According to this system, a lamellar structure can be suitably formed. Therefore, the TiAl alloy member can be easily molded with a reduction in high temperature properties suppressed.

### Advantageous Effects of Invention

According to the present invention, the TiAl alloy member can be easily molded with a reduction in high temperature properties suppressed.

### BRIEF DESCRIPTION OF DRAWINGS

FIG. 1 is a block diagram illustrating a configuration of a system for producing a TiAl alloy member according to an embodiment.

FIG. 2 is a schematic view of a molding device according to the embodiment.

FIG. 3 is a schematic block diagram of a controller according to the embodiment.

FIG. 4 is a schematic view of a heat treatment device according to the embodiment.

FIG. 5 is a schematic view illustrating an example of a phase diagram of a TiAl alloy member.

FIG. 6 is a flow chart illustrating a flow of producing a TiAl alloy member according to the embodiment.

FIG. 7 is a view illustrating a photograph of an inner structure of a TiAl alloy member according to Example 1.

FIG. 8 is a view illustrating a photograph of an inner structure of the TiAl alloy member according to Example 1.

FIG. 9 is a view illustrating a photograph of an inner structure of a TiAl alloy member according to Example 2.

FIG. 10 is a graph illustrating results of measurement of tensile strength at each temperature in Examples and Comparative Example.

### DESCRIPTION OF EMBODIMENTS

Hereinafter, preferred embodiments of the present invention will be described in detail with reference to the accompanying drawings. The present invention is not limited by the embodiments, and in a case where a plurality of embodiments are conceivable, the present invention includes an embodiment including such embodiments in combination.

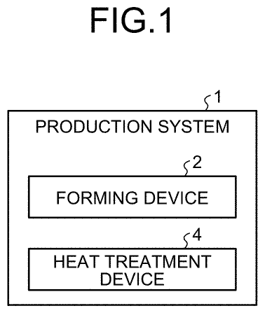

FIG. 1 is a block diagram illustrating a configuration of a system for producing a TiAl alloy member according to an embodiment. A production system 1 according to the embodiment is a system for performing a method for producing a TiAl alloy member. A TiAl alloy member in the embodiment is an alloy in which Ti and Al are bonded, and specifically, an intermetallic compound in which Ti and Al are bonded (for example, TiAl, Ti₃Al, and Al₃Ti).

As the TiAl alloy member in the embodiment, a TiAl alloy member containing 38 to 47 at % Al with the balance being Ti and inevitable impurities may be used. As the TiAl alloy member, for example, a TiAl alloy member containing 38 to 45 at % Al and 3 to 10 at % Mn with the balance being Ti and inevitable impurities may be used. As the TiAl alloy member, for example, a TiAl alloy member containing 38 to 45 at % Al and one or more of Cr or V in a concentration of 3 to 10 at % with the balance being Ti and inevitable impurities may be used. Each of the TiAl alloy members having compositions exemplified above may further contain at least one of 1 to 2.5 at % Nb, one or more of Mo, W, or Zr in a concentration of 0.2 to 1.0 at %, 0.1 to 0.4 at % C, and one or more of Si, Ni, or Ta in a concentration of 0.2 to 1.0 at %.

As illustrated in FIG. 1, the production system 1 includes a molding device 2 and a heat treatment device 4. The molding device 2 is a device for performing a molding step according to the embodiment. By the molding device 2, a laminated body L that is three-dimensionally shaped article of the TiAl alloy member is molded from powder P that is powder of the TiAl alloy member. The heat treatment device 4 is a device for performing a heat treatment step according to the embodiment. By the heat treatment device 4, the laminated body L is heat-treated to produce a member M that is the heat-treated TiAl alloy member. Since the member M is thus produced by heat-treating the laminated body L molded from the powder P, it can be said that the member M, the laminated body L, and the powder P are the TiAl alloy member having the composition described above. The production system 1 is a system for producing a turbine blade of a low-pressure turbine of an aircraft engine, a turbine wheel of a turbocharger for a vehicle, and the like, as the member M, for example. The member M is not limited to the turbine blade and the turbine wheel, and may be used in any applications.

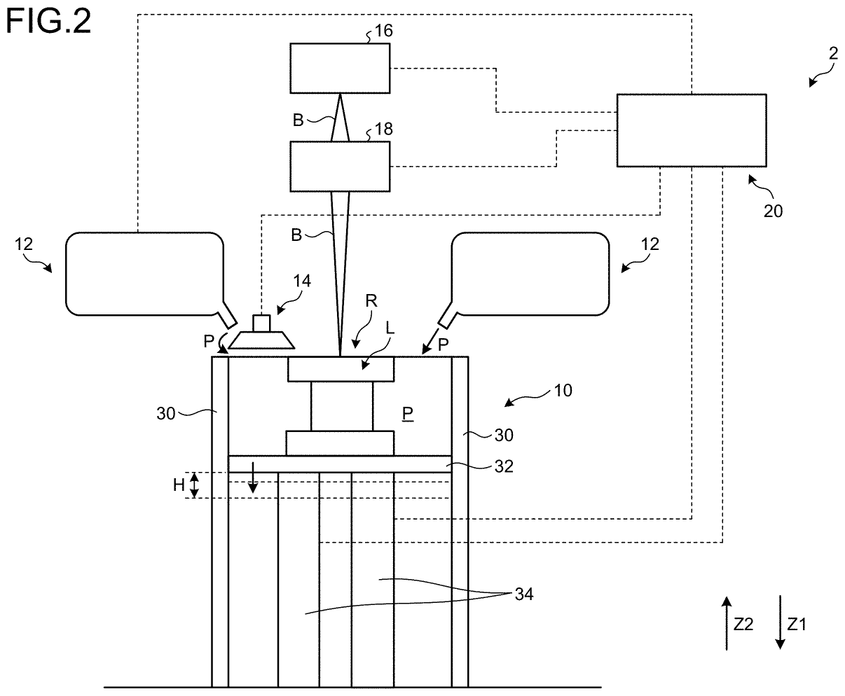

FIG. 2 is a schematic view of the molding device according to the embodiment. In the molding device 2 according to the embodiment, a solidified body that is obtained by melting and solidifying or sintering the powder P by irradiation with a beam B is repeatedly produced, to mold the laminated body L in which the solidified bodies are laminated. As illustrated in FIG. 2, the molding device 2 includes a molding chamber 10, a powder feeder 12, a blade 14, an irradiation source unit 16, an irradiation unit 18, and a controller 20. In the molding device 2, the powder P is supplied from the powder feeder 12 to the molding chamber 10 under control of the controller 20, the powder P supplied to the molding chamber 10 is irradiated with the beam B from the irradiation source unit 16 and the irradiation unit 18, to melt and solidify or sinter the powder P, and the laminated body L is molded. Hereinafter, a direction Z1 is a direction from an upper side to a lower side of a vertical direction, and a direction Z2 is a direction opposite to the direction Z1, or a direction from the lower side to the upper side of the vertical direction.

The molding chamber 10 includes a housing 30, a stage 32, and a movement mechanism 34. The housing 30 is a housing that is opened on an upper side, that is, on a side of the direction Z2. The stage 32 is arranged in the housing 30 so as to be surrounded by the housing 30. The stage 32 is configured movably in the directions Z1 and Z2 in the housing 30. A space R surrounded by an upper surface of the stage 32 and an inner circumferential surface of the housing 30 is a space R to which the powder P is supplied. The movement mechanism 34 is connected to the stage 32. The movement mechanism 34 moves the stage 32 in the vertical direction, that is, in the directions Z1 and Z2 under control of the controller 20.

The powder feeder 12 has a mechanism for storing the powder P in the inside thereof. Supply of the powder P is controlled by the controller 20, and under control of the controller 20, the powder feeder 12 supplies the powder P to the space R above the stage 32 from a supply port 12A. The blade 14 is a squeezing blade in which the powder P supplied to the space R is horizontally swept (squeezed). The blade 14 is controlled by the controller 20.

The irradiation source unit 16 is an irradiation source of the beam B. The beam B is a flux of particles or waves travelling together, and in the embodiment, the beam B is an electron beam. In the embodiment, the irradiation source unit 16 is a tungsten filament. The beam B is not limited to an electron beam as long as it is a beam capable of sintering or melting the powder P. The irradiation source unit 16 may be any irradiation source unit as long as it can emit the beam B. For example, the beam B may be a laser beam.

The irradiation unit 18 is provided above the molding chamber 10, that is, on the side of the direction Z2. The irradiation unit 18 has a mechanism in which the molding chamber 10 is irradiated with the beam B from the irradiation source unit 16. For example, the irradiation unit 18 has an optical element such as an astigmatism lens, a converging lens, and a polarizing lens. For example, the irradiation unit 18 has a scanning mechanism in which scanning with the beam B is possible under control of the controller 20. When the molding chamber 10 is irradiated with the beam B from the irradiation source unit 16 with scanning, the powder P that is spread on the stage 32 is irradiated at a particular position with the beam. At the position irradiated with the beam B, the powder P is melted and solidified (solidified after melting), or sintered.

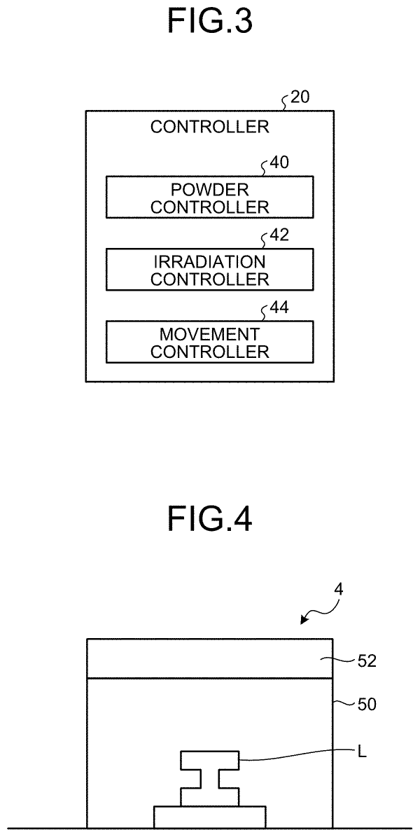

FIG. 3 is a schematic block diagram of the controller according to the embodiment. For example, the controller 20 is a computer, which includes a processor configured by a central processing unit (CPU) or the like, and a storage unit. As illustrated in FIG. 2, the controller 20 includes a powder controller 40, an irradiation controller 42, and a movement controller 44. The powder controller 40, the irradiation controller 42, and the movement controller 44 are realized by reading a computer program from the storage unit by the controller 20, and processing is conducted for them. The powder controller 40, the irradiation controller 42, and the movement controller 44 may each be a separate hardware.

The powder controller 40 controls supply of the powder P to the stage 32. For example, the powder controller 40 controls the powder feeder 12 to supply the powder P onto the stage 32 that is lowered by a movement distance H. The powder controller 40 controls the blade 14 to squeeze the powder P on the stage 32 using the blade 14.

The irradiation controller 42 controls irradiation of the powder P on the stage 32 with the beam B. For example, the irradiation controller 42 reads three-dimensional data stored in the storage unit, sets a scanning route of the beam B based on the three-dimensional data, and controls the irradiation unit 18 so as to irradiate the set scanning route with the beam B.

The movement controller 44 controls the movement mechanism 34 to move the stage 32. The movement controller 44 moves the stage 32 by the movement distance H to the side of the direction Z1 after a solidified body A is formed by irradiation of the powder P with the beam B.

The molding device 2 has the following configuration. In the molding device 2, the powder P is supplied to the stage 32 by the powder feeder 12 that is controlled by the powder controller 40, and the powder P on the stage 32 is irradiated with the beam B by the irradiation source unit 16 and the irradiation unit 18 that are controlled by the irradiation controller 42. At a position irradiated with the beam B, the powder P is sintered or melted and solidified to form the solidified body A. In the molding device 2, after the solidified body A is molded, the stage 32 is moved by the movement distance H to the side of the direction Z1 by the movement mechanism 34 that is controlled by the movement controller 44. In the molding device 2, the powder P is supplied to the stage 32, that is, onto the solidified body A, by the powder feeder 12, and the powder P on the stage 32 is irradiated with the beam B by the irradiation source unit 16 and the irradiation unit 18. Thus, another solidified body A is laminated on the solidified body A. In the molding device 2, after the other solidified body A is laminated, the stage 32 is moved by the movement distance H to the side of the direction Z1, and the same treatment as described above is repeated. In the molding device 2, such a treatment is repeated to laminate the solidified bodies A. Thus, the laminated body L is molded.

In the molding device 2, before the powder P is melted and solidified or sintered, that is, before the solidified body is produced, the powder P that is in the periphery of the powder P to form the solidified body may be preheated by heating the powder P in the periphery of the powder P to form the solidified body. In the molding device 2, heating of the powder P in the periphery of the powder P to form the solidified body may be continued during production of the solidified body.

Therefore, the molding device 2 is a powder bed fusion molding device for repeating supply of the powder P and irradiation with the beam B every time the stage 32 is lowered. The molding device 2 is not limited to the powder bed fusion molding device as long as it is a device in which the solidified body obtained by solidifying the powder P is laminated to mold the laminated body L. For example, the molding device 2 may be a device in which the powder P melted by irradiation with the beam B is added dropwise and the laminated body L is molded.

In order to suitably produce a near lamellar structure described below, for example, it is preferable that a condition of molding the laminated body L by the molding device 2 be set as follows. For example, it is preferable that the energy density applied to the irradiation source unit 16 to emit the beam B be set to 5.0 J/mm³ or more and 50 J/mm³ or less. It is preferable that the applied voltage to the irradiation source unit 16 to emit the beam B be set to 50 kV or more and 70 kV or less. It is preferable that the spot diameter of the beam B at a position where the powder P is irradiated be set to 50 μm or more and 200 μm or less. It is preferable that the scanning rate of the beam B be 0.1 m/s or more and 5.0 m/s or less. It is preferable that the heating temperature at which the powder P in the periphery of the powder P to form the solidified body is heated be set to 0.5 or more and 0.8 or less times the melting point of the powder P.

Next, the heat treatment device 4 will be described. FIG. 4 is a schematic view of the heat treatment device according to the embodiment. The heat treatment device 4 is a device for heating the laminated body L produced by the molding device 2. As illustrated in FIG. 4, the heat treatment device 4 includes a heating chamber 50 and a heater 52. The heating chamber 50 is a container or a chamber for housing the laminated body L. The heater 52 is a heat source for heating the inside of the heating chamber 50 to a predetermined temperature.

In the heat treatment device 4, the inside of the heating chamber 50 is heated to a setting temperature T by the heater 52 with the laminated body L housed in the heating chamber 50, and this state where the inside of the heating chamber 50 is heated to the setting temperature T is held for a predetermined time. Thus, the laminated body L is heated at the setting temperature T for the predetermined time. After heating at the setting temperature T for the predetermined time, the laminated body L is cooled to produce the member M. Specifically, the member M is the laminated body L that is cooled after a heat treatment at the setting temperature T.

In the embodiment, the setting temperature T falls within a range of single phase temperature that is a temperature at which the laminated body L as the TiAl alloy member is an α single phase. The single phase temperature is a temperature range where the laminated body L contains a α phase, but does not contain α phase other than the phase α (in the embodiment, an α₂ phase, a β phase, a γ phase, and an L phase as described below). The setting temperature T is not limited to the range of the single phase temperature, and may be a temperature that is equal to or higher than a transformation start temperature and lower than α melting point. The transformation start temperature is a temperature at which phase transformation to the α phase in the laminated body L that is the TiAl alloy member is initiated. The melting point is a melting point of the laminated body L that is the TiAl alloy member. The predetermine time when the state of the setting temperature T is held is preferably 0.5 hour or more and 10 hours or less. After heating to the setting temperature T, the laminated body L is cooled by naturally cooling to normal temperature. However, the cooling is not limited. For example, the laminated body L may be cooled by holding the laminated body L to a predetermined temperature that is lower than the setting temperature T.

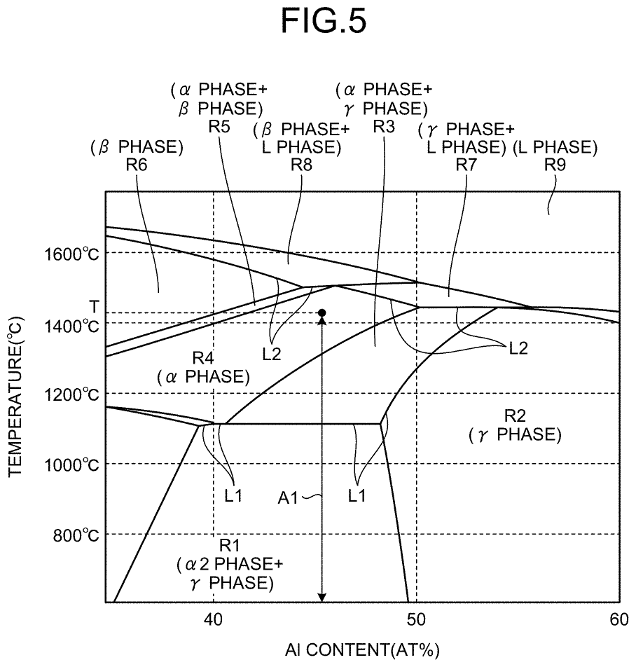

Hereinafter, the setting temperature T will be described using a phase diagram. FIG. 5 is a schematic view illustrating an example of a phase diagram of the TiAl alloy member. FIG. 5 is an example of the phase diagram of the TiAl alloy member. A horizontal axis exhibits the concentration of Al, that is, the content (at %) of Al, and a vertical axis exhibits the temperature of the TiAl alloy member.

As illustrated in FIG. 5, a metal phase of the TiAl alloy member varies depending on the content of Al and the temperature of the TiAl alloy member. In FIG. 5, a region R1 is a region where the TiAl alloy member is configured to contain an α₂ phase (a cubic closest packed crystal of Ti₃Al) and a γ phase (a face-centered cubic crystal of TiAl). A region R2 is a region corresponding to a position where the content of Al is increased relative to the region R1. The region R2 is a region where the TiAl alloy member is a γ single phase. A region R3 is a region corresponding to a position where the temperature of the TiAl alloy member is increased relative to the region R1. The region R3 is a region where the TiAl alloy member is configured to contain an α phase (a cubic closest packed crystal of Ti simple substance) and a γ phase. A region R4 is a region corresponding to a position where the temperature of the TiAl alloy member is increased relative to the region R1 and a position where the content of Al is decreased relative to the region R3. The region R4 is a region where the TiAl alloy member is an α single phase.

A region R5 is a region corresponding to a position where the temperature of the TiAl alloy member is increased relative to the region R4. The region R5 is a region where the TiAl alloy member is configured to contain an α phase and a β phase (a body-centered cubic crystal of Ti). A region R6 is a region corresponding to a position where the temperature of the TiAl alloy member is increased relative to the region R5. The region R6 is a region where the TiAl alloy member is a β single phase. A region R7 is a region corresponding to a position where the temperature of the TiAl alloy member is increased relative to the region R3. The region R7 is a region where the TiAl alloy member is configured to contain a γ phase and an L phase (liquid phase). A region R8 is a region corresponding to a position where the temperature of the TiAl alloy member is increased relative to the regions R5, R6, R7, and R8. The region R8 is a region where the TiAl alloy member is configured to contain a β phase and an L phase (liquid phase). A region R9 is a region corresponding to a position where the temperature of the TiAl alloy member is increased relative to the regions R7 and R8. The region R9 is a region where the TiAl alloy member is a single L phase.

As described above, the region R4 is a region to form a α single phase. Therefore, a line surrounding the region R4, that is, a border line between the region R4 and other regions exhibits upper and lower limit values of the single phase temperature at each Al concentration. In other words, the single phase temperature is a temperature within a range of the region R4. In the embodiment, the setting temperature T is the temperature within the region R4. The Al content of a laminated body L according to one example of the embodiment is 46 at %, and the setting temperature T of one example is 1,300° C. or higher that is the lower limit value of the region R4 where the Al content is 46 at %, and 1,500° C. or lower that is the upper limit value of the region R4 where the Al content is 46 at %. For example, the setting temperature T may be 1,350° C.

In the heat treatment device 4, after heating at the setting temperature T that is set within the range of the region R4, the laminated body L is cooled to normal temperature. In this case, the laminated body L is cooled as illustrated by an arrow Al in FIG. 5.

As described above, the setting temperature T may be a temperature that is equal to or higher than the transformation start temperature and lower than the melting point. Herein, the regions R3, R4, and R5 are regions containing an α phase. A line L1 is a border line between a region containing the regions R3, R4, and R5 together and a region on a lower temperature side apart from the region. In this case, the line L1 exhibits a boundary where a phase transformation to the α phase is initiated at a temperature that exceeds the line L1. Specifically, the line L1 exhibits the transformation start temperature at each Al concentration. The regions R7 and R8 are regions containing the L phase. A line L2 is a border line between a region containing the regions R7 and R8 together and a region on the lower temperature side apart from the region. In this case, the line L2 exhibits a boundary where a phase transformation to the L phase is initiated at a temperature that exceeds the line L2. Specifically, the line L2 exhibits the melting point at each Al concentration. Therefore, the setting temperature T may be a temperature that is equal to or higher than the line L1 and equal to or lower than the line L2.

Since FIG. 5 is a binary phase diagram of Ti and Al, a phase diagram of the TiAl alloy member may be different from that of FIG. 5 according to another metal element contained. However, even in any phase diagram, the setting temperature T is a temperature that is equal to or higher than the transformation start temperature and lower than the melting point, and preferably falls within a range of the region R4 to form an α single phase.

Thus, in the production system 1 according to the embodiment, the laminated body L that is the TiAl alloy member is molded by the molding device 2, and is heat-treated at the setting temperature T by the heat treatment device 4, to produce the member M that is the TiAl alloy member. Since the laminated body L is molded from the powder P by the molding device 2, the production system 1 allows the TiAl alloy member, in which machining is difficult, to be easily molded into a desired shape. When in the production system 1, the laminated body L that is the TiAl alloy member is molded by the molding device 2, a near lamellar structure can be suitably formed. When the laminated body L that is the near lamellar structure is heat-treated at the setting temperature T, the member M can be suitably transformed into a lamellar structure. Specifically, in the production system 1, after the near lamellar structure is formed by the molding device 2, the laminated body L with the near lamellar structure is heat-treated at the setting temperature T that includes the α phase. Thus, the lamellar structure can be suitably formed. Here, the lamellar structure indicates a linear structure in which orientation is arranged, and the near lamellar structure indicates a structure consisting of the lamellar structure and a small amount of γ phase. The lamellar structure has high strength, and a reduction in strength at a high temperature is decreased. Therefore, when the near lamellar structure is thus formed and a heat treatment is performed in the production system 1 according to the embodiment, the lamellar structure can be suitably formed, and a reduction in strength can be suppressed.

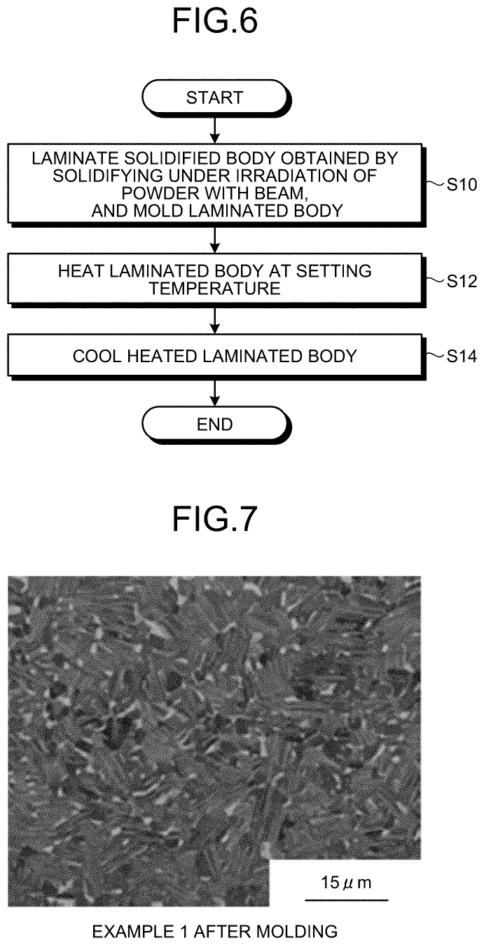

Next, a flow of a method for producing the member M in the embodiment will be described. FIG. 6 is a flow chart illustrating a flow of producing the TiAl alloy member according to the embodiment. As illustrated in FIG. 6, in the production system 1, the solidified body obtained by solidification under irradiation of the powder P with the beam B is laminated by the molding device 2, to mold the laminated body L (Step S10; molding step). After the laminated body L is molded, the laminated body L is heated at the setting temperature T by the heat treatment device 4 in the production system 1 (Step S12; heat treatment step), and the heated laminated body L is cooled (Step S14; cooling step), to produce the member M that is the TiAl alloy member.

As described above, the method for producing the TiAl alloy member according to the embodiment includes the molding step and the heat treatment step. In the molding step, the solidified body obtained by melting and solidifying or sintering the powder P of the TiAl alloy by irradiation of the powder P with the beam B is laminated, to mold the laminated body L. In the heat treatment step, the laminated body L is heated at the setting temperature T that is equal to or higher than a temperature at which a phase transformation to an α phase is initiated, to produce the member M that is the TiAl alloy member. The method for producing the TiAl alloy member may be performed by the production system 1, the molding step is performed by the molding device 2, and the heat treatment step is performed by the heat treatment device 4.

In the method for producing the TiAl alloy member according to the embodiment, the solidified body in which the powder P is melted and solidified or sintered is laminated to mold the laminated body L. According to this method, the TiAl alloy member, in which machining is difficult, can be easily molded into a desired shape. Furthermore, according to this method, the laminated body L with the near lamellar structure can be suitably formed. Furthermore, when the laminated body L is heat-treated at the setting temperature T, the member M with the lamellar structure can be suitably formed. According to this method, the TiAl alloy member can be easily formed with a reduction in high temperature properties suppressed.

At the heat treatment step in the method for producing the TiAl alloy member according to the embodiment, the setting temperature T is a single phase temperature at which the laminated body L is an α single phase. According to this method, by a heat treatment at the setting temperature T at which the laminated body L with the near lamellar structure is an α single phase, the member M with the lamellar structure can be more suitably formed. According to this method, a reduction in high temperature properties of the TiAl alloy member can be more suitably suppressed.

At the heat treatment step in the method for producing the TiAl alloy member according to the embodiment, the setting temperature T is 1,300° C. or higher and 1,500° C. or lower. According to this method, it is possible that the laminated body L is heat-treated at an α single phase temperature. Therefore, a reduction in high temperature properties of the TiAl alloy member can be more suitably suppressed.

The method for producing the TiAl alloy member according to the embodiment further includes the cooling step of cooling the heated laminated body L. According to this method, when the laminated body L heat-treated at the setting temperature T is cooled to produce the member M, the lamellar structure can be suitably produced, and a reduction in high temperature properties of the TiAl alloy member can be suitably suppressed.

At the molding step in the method for producing a TiAl alloy member according to the embodiment, the powder P is irradiated with an electron beam as the beam B. According to this method, the powder P is melted by the electron beam. Therefore, the laminated body L with the near lamellar structure can be suitably molded, and a reduction in high temperature properties of the TiAl alloy member can be suitably suppressed.

### Examples

Next, Examples of the embodiment will be described. In Examples, a laminated body was molded under the following molding condition using an electron beam melting (EBM) molding device manufactured by ARCAM. In the molding condition, the heating temperature at which powder P in the periphery of powder P to form a solidified body was heated was 1,060° C., the applied current to an irradiation source unit 16 was 0.5 mA or more and 2.5 mA or less, the applied voltage to the irradiation source unit 16 was 60 kV, the spot diameter of a beam B at a position where the powder P was irradiated was 15 μm, the movement distance H was 90 μm, and the scanning rate of the beam B was 0.1 m/s or more and 7.6 m/s or less. As the powder P, powder containing 46.4 at % Al, 6.36 at % Nb, 0.57 at % Cr, and 0.07 at % O with the balance being Ti was used. As the powder P, powder having a particle size distribution that was determined by a laser diffractometry-scattering method of 45 μm or more and 150 μm or less and an average particle diameter that was determined by a laser diffractometry-scattering method of 100 μm was used. In Example 1, a laminated body obtained by laminating under such a condition was heat-treated at a setting temperature T of 1,300° C. for 1 hour, to produce a TiAl alloy member.

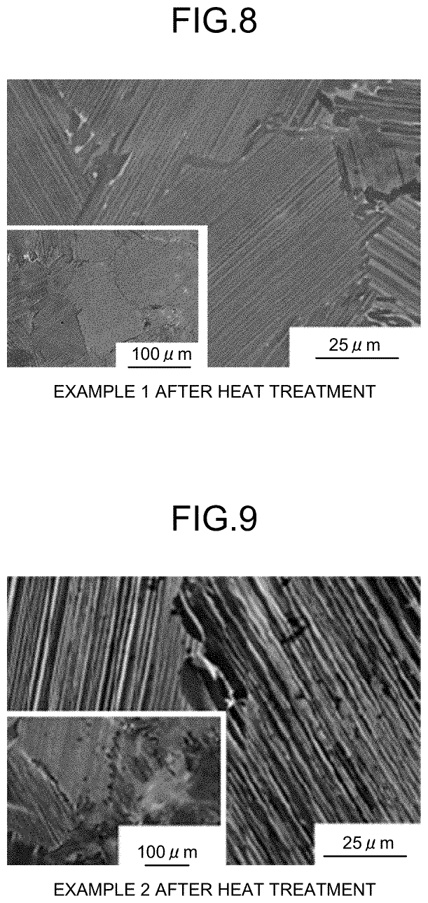

FIGS. 7 and 8 are a view illustrating a photograph of an inner structure of the TiAl alloy member according to Example 1. FIG. 7 is a photograph of the TiAl alloy member after molding and before a heat treatment. It is found that as illustrated in FIG. 7, by molding the TiAl alloy member of Example 1, that is, the laminated body by a molding device, a near lamellar structure is formed. FIG. 8 is a photograph of the TiAl alloy member after the heat treatment. It is found that as illustrated in FIG. 8, by the heat treatment of the TiAl alloy member of Example 1, a lamellar structure is formed.

FIG. 9 is a view illustrating a photograph of an inner structure of a TiAl alloy member according to Example 2. In Example 2, a laminated body molded under the same condition as that in Example 1 was heat-treated at a setting temperature T of 1,350° C. for 1 hour, to produce a TiAl alloy member. FIG. 9 is a photograph of the TiAl alloy member after the heat treatment. It is found that as illustrated in FIG. 9, by the heat treatment of the TiAl alloy member of Example 2, a lamellar structure is also formed.

The tensile strength of the TiAl alloy member of Example 1 and a TiAl alloy member of Comparative Example was measured at each temperature. The TiAl alloy member of Comparative Example was molded by casting an ingot of the TiAl alloy member, and then heat-treated at 1,370° C. for 1.0 hour.

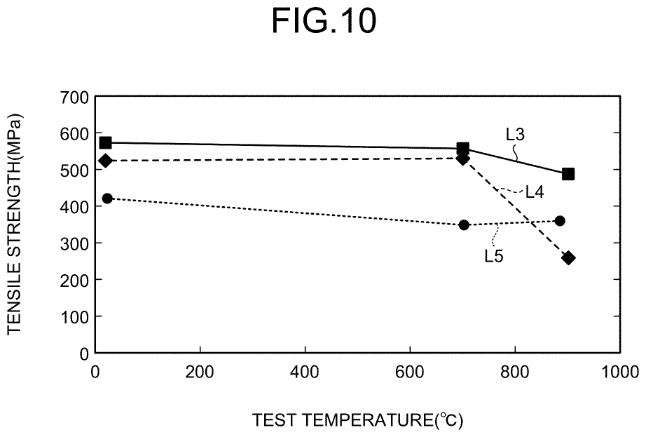

FIG. 10 is a graph illustrating results of measurement of tensile strength at each temperature in Examples and Comparative Example. In FIG. 10, a horizontal axis is the temperature of a TiAl alloy member, and a vertical axis is the tensile strength. In FIG. 10, a line L3 is the tensile strength of the TiAl alloy member after a heat treatment under the condition of Example 1, a line L4 is the tensile strength of the TiAl alloy member after molding and before a heat treatment under the condition of Example 1, and a line L5 is the tensile strength of the TiAl alloy member after a heat treatment under the condition of Comparative Example. It is found that as represented by the lines L3 and L4, the heat treatment at the setting temperature T suppresses a reduction in strength, particularly at a high temperature. It is found that as represented by the lines L3 and L5, the strength of the TiAl alloy member molded from the powder P is higher than the strength of the TiAl alloy member molded by casting.

The embodiment of the present invention is described, but embodiments are not limited by the content of this embodiment. The components described above include those that can be readily assumed by one skilled in the art, can be substantially the same, and falls within a range of so-called equivalent. The components can be appropriately combined with each other. Various omissions, replacements, or modifications of the components can be made without departing from the spirit of the embodiments.

### REFERENCE SIGNS LIST

1 Production system
2 Molding device
4 Heat treatment device
10 Molding chamber
12 Powder feeder
14 Blade
16 Irradiation source unit
18 Irradiation unit
20 Controller
50 Heating chamber
52 Heater
B Beam
L Laminated body
M Member
P Powder
T Setting temperature

1. A method for producing a TiAl alloy member, the method comprising:
a molding step of laminating a solidified body obtained by melting and solidifying or sintering powder of a TiAl alloy by irradiation of the powder with a beam, to mold a laminated body; and
a heat treatment step of heating the laminated body at a setting temperature that is equal to or higher than a temperature at which a phase transformation to an α phase is initiated, to produce a TiAl alloy member.

2. The method for producing a TiAl alloy member according to claim 1, wherein at the heat treatment step, the setting temperature is a temperature at which the laminated body is an α single phase.

3. The method for producing a TiAl alloy member according to claim 2, wherein at the heat treatment step, the setting temperature is 1,300° C. or higher and 1,500° C. or lower.

4. The method for producing a TiAl alloy member according to any one of claims 1 to 3, further comprising a cooling step of cooling the heated laminated body.

5. The method for producing a TiAl alloy member according to any of claims 1 to 4, wherein at the molding step, the powder is irradiated with an electron beam as the beam.

6. A system for producing a TiAl alloy member, the system comprising:
a molding device in which a solidified body obtained by melting and solidifying or sintering powder of a TiAl alloy by irradiation of the powder with a beam is laminated, to mold a laminated body; and
a heat treatment device in which the laminated body is heated at a setting temperature that is equal to or higher than a temperature at which a phase transformation to an α phase is initiated, to produce a TiAl alloy member.
